(19) United States
(12) Patent Application Publication
(10) Pub. No.: US 2006/0089436 A1
(43) Pub. Date: Apr. 27, 2006

(54) Thermal stabilizer compositions for halogen-containing vinyl polymers

(76) Inventor: Steven Christopher Austen, Loveland, OH (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/242,352

(22) Filed: Oct. 3, 2005

Related U.S. Application Data
(60) Provisional application No. 60/622,366, filed on Oct. 27, 2004.

(51) Int. Cl. C08K 5/32

(52) U.S. Cl. 524/236

(57) ABSTRACT

Synergistic stabilizer compositions are employed to stabilize halogen-containing vinyl polymers from, for example, degradation and discoloration. The stabilizer compositions comprise an aromatic amine and at least one additional co-stabilizer. The co-stabilizer is a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers. Also described are halogen-containing vinyl polymer compositions comprising an aromatic amine, and articles comprising the polymeric compositions.

### BACKGROUND

This invention relates to stabilizer compositions for halogen-containing vinyl polymers, the stabilized halogen-containing vinyl polymer compositions and articles formed therefrom, and methods for stabilizing halogen-containing vinyl polymers.

Halogen-containing vinyl polymers, for example, poly(vinyl chloride) (PVC), copolymers of vinyl chloride and vinyl acetate, and poly(vinylidene chloride), are commonly used for fabricating a variety of articles such as pipes, window casings, siding, bottles, wall covering, and packaging film. There have been many attempts to add stabilizers to halogen-containing vinyl polymers to improve the color hold in the polymer resins, particularly the color hold within the processing window, e.g., during the initial processing and during any subsequent re-processing. Stabilizer compositions comprising tin, cadmium, and/or lead can be effective for minimizing discoloration during initial processing, as well as during any subsequent re-processing, however, there is interest in developing stabilizer compositions that are free of these metals and/or reducing the amounts of these metals for environmental, cost, and other reasons.

Stabilizers free of tin, cadmium, and/or lead include a type of aromatic amine as described in U.S. Pat. No. 4,642,322. The aromatic amines may be mixed with other stabilizers such as epoxidised fatty acid esters, e.g., epoxidized soy bean oil, phosphites, metal carboxylates, metal phenolates, inorganic salts such as ZnCl₂, organo-tin compounds, and antimony-trimercaptocarboxylic acid esters.

Stabilizer compositions comprising other types of amines have also been described. For example, U.S. Pat. No. 3,288,744, discloses that tris(hydroxymethyl)aminomethane is useful for stabilizing halogen-containing vinyl polymers, but that other alkanolamines are unexpectedly poorer. DE 101 18 179 A1 discloses stabilizer compositions containing an amino alcohol, together with a perchlorate salt, certain types of enamines, or both. Exemplary enamines include alpha, beta-unsaturated beta-aminocarboxylic acids such as beta-crotonic acid esters and aminouracils.

Nonetheless, there remains a need in the art for improved stabilizer compositions for halogen-containing vinyl polymers that provide improved resistance to discoloration during processing and/or use.

### STATEMENT OF THE INVENTION

In a first aspect, there is provided a thermal stabilizer composition comprising an aromatic amine of the formula: 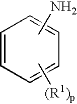
wherein p is 1 or 2, and wherein each R¹ is independently H, NO₂, alkenyl, alkoxy, C₁ to C₁₈ ester alkyl, C₁ to C₁₈ alkanoyl, or —(C═O)R², wherein each R² group is independently unsubstituted or substituted by one to three —OH, C₁ to C₄ alkoxy groups, phenoxy groups, or a combination thereof; and

a co-stabilizer, wherein the co-stabilizer is a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers.

In a second aspect, there is provided a stabilized polymer composition comprising a halogen-containing vinyl polymer and the above-described stabilizer composition.

In another aspect, there is provided an article comprising the above-described stabilized polymer composition.

In another aspect, there is provided a method of stabilizing a polymer composition, comprising adding the above-described stabilizer composition to a halogen-containing vinyl polymer composition.

It has been found that certain aromatic amines provide synergistic stabilization when combined with particular co-stabilizers.

### DETAILED DESCRIPTION

The terms “a” and “an” herein do not denote a limitation of quantity, but rather denote the presence of at least one of the referenced item. The abbreviation “phr” refers to parts by weight of a particular component per 100 parts by weight of the halogen-containing vinyl polymer.

As used herein, “alkyl” is intended to include both branched and straight-chain saturated aliphatic hydrocarbon groups, having the specified number of carbon atoms. Thus, the term C₁ to C₆ alkyl as used herein includes alkyl groups having 1 to 6 carbon atoms. When C₀ to Cₙ alkyl is used herein in conjunction with another group, for example, (phenyl)C₀ to C₄ alkyl, the indicated group, in this case phenyl, is either directly bound by a single covalent bond (C₀), or attached by an alkyl chain having the specified number of carbon atoms, in this case 1 to about 4 carbon atoms. Examples of alkyl include, but are not limited to, methyl, ethyl, n-propyl, isopropyl, n-butyl, t-butyl, n-pentyl, and sec-pentyl.

“Alkenyl” as used herein, indicates a hydrocarbon chain of either a straight or branched configuration having one or more carbon-carbon double bond bonds, which may occur at any stable point along the chain. Examples of alkenyl groups include ethenyl and propenyl.

“Alkoxy” represents an alkyl group as defined above with the indicated number of carbon atoms attached through an oxygen bridge. Examples of alkoxy include, but are not limited to, methoxy, ethoxy, n-propoxy, i-propoxy, n-butoxy, 2-butoxy, t-butoxy, n-pentoxy, 2-pentoxy, 3-pentoxy, isopentoxy, neopentoxy, n-hexoxy, 2-hexoxy, 3-hexoxy, and 3-methylpentoxy.

“Alkanoyl” indicates an alkyl group as defined above, attached through a keto (—(C═O)—) bridge. Alkanoyl groups have the indicated number of carbon atoms, with the carbon of the keto group being included in the numbered carbon atoms. For example a C₂alkanoyl group is an acetyl group having the formula CH₃(C═O)—.

As used herein, the term “aryl” indicates aromatic groups containing only carbon in the aromatic ring or rings. Typical aryl groups contain 1 to 3 separate, fused, or pendant rings and 6 to 18 ring atoms, without heteroatoms as ring members. When indicated, such aryl groups may be further substituted with carbon or non-carbon atoms or groups. Such substitution may include fusion to a 5 to 7-membered saturated cyclic group that optionally contains 1 or 2 heteroatoms independently chosen from N, O, and S, to form, for example, a 3,4-methylenedioxy-phenyl group. Aryl groups include, for example, phenyl, naphthyl, including 1-naphthyl and 2-naphthyl, and bi-phenyl.

“Phenoxy” represents an phenyl group as defined above with the indicated number of carbon atoms attached through an oxygen bridge.

The term “ester alkyl” indicates and alkyl group as define above attached through an ester linkage, i.e. a group of the formula —O(C═O)alkyl.

“Alkoxy carbonyl” refers to an alkoxy group adjacent a carbonyl group, i.e., a group of the formula alkyl —O(C═O)—.

In the term “(aryl)alkyl”, aryl and alkyl are as defined above, and the point of attachment is on the alkyl group. This term encompasses, but is not limited to, benzyl, phenylethyl, and piperonyl. Likewise, in the term (aryl)carbohydryl, aryl and carbohydryl are as defined above and the point of attachment is on the carbohydryl group, for example a phenylpropen-1-yl group.

The term “alkylthio” indicates an alkyl group as defined above attached through a sulfur linkage, i.e. a group of the formula alkyl-S—. Examples include ethylthio and pentylthio.

An effective stabilizer composition for halogen-containing vinyl polymers comprises an aromatic amine in combination with at least one additional co-stabilizer. The co-stabilizer comprises a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers. The aromatic amine provides unexpectedly improved thermal stability through synergistic interactions with other stabilizer components. In a particularly advantageous feature, the aromatic amine can be substituted for one or more components in a standard multi-component thermal stabilizer composition. The aromatic amine may also be added as an additional stabilizer to a multi-component stabilizer composition. Further, the aromatic amine can mitigate UV instability which may occur in certain stabilizer compositions.

The aromatic amine has the formula: 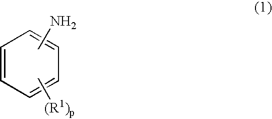
wherein p is 1 or 2, and wherein each R¹ is independently H, NO₂, alkenyl, alkoxy, C₁ to C₁₈ ester alkyl, C₁ to C₁₈ alkanoyl, or —(C═O)R², wherein each R² group is independently unsubstituted or substituted by one to three —OH, C₁ to C₄ alkoxy groups, phenoxy groups, or a combination thereof.

In one embodiment, R¹ is NO₂. In this embodiment, the aromatic amine comprises a nitroaniline such as, for example, 4-nitroaniline.

In another embodiment, the aromatic amine has the formula: 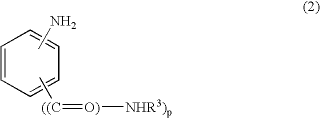
wherein p is 1 or 2; and each R³ is independently —OH, —NH₂, or C₁ to C₁₈ alkyl, phenyl, (aryl)alkyl, or a mixture thereof.

Examples of compounds of formula 2 are anthranilamide, anthranilic acid hydroxylamide, anthranilic acid amide, 3-aminobenzoic acid amide, 4-aminobenzoic acid amide, anthranilic acid N-methylamide, anthranilic acid N-ethylamide, anthranilic acid N-(1′,1′-dihydroxymethyl-2′-hydroxyethyl)-amide, anthranilic acid N-n-propylamide, anthranilic acid N-isopropylamide, anthranilic acid N-n-butylamide, anthranilic acid N-n-hexylamide, anthranilic acid N-n-octylamide, anthranilic acid N-(2′-ethylhexyl)-amide, anthranilic acid N-(1′-ethylhexyl)-amide, anthranilic acid N-n-decylamide, anthranilic acid N-n-dodecylamide, anthranilic acid N-n-tetradecylamide, anthranilic acid N-n-hexadecylamide, anthranilic acid N-n-octadecylamide, anthranilic acid N-phenylamide, anthranilic acid N-benzylamide, anthranilic acid N-(2′,3′-dihydroxypropyl)-amide, anthranilic acid N-(2′-hydroxyethyl)-amide, anthranilic acid N-(2′-hydroxy-n-propyl)-amide, anthranilic acid N-(3′-hydroxy-n-propyl)-amide, anthranilic acid N-(2′-hydroxy-2′-phenylethyl)-amide, anthranilic acid N-(p-hydroxyphenyl)-amide, anthranilic acid N-(p-phenoxyphenyl)-amide, anthranilic acid N-(2′-hydroxy-3′-n-butoxy-n-propyl)-amide, 3-aminobenzoic acid N-(2′-hydroxyethyl)-amide, 4-aminobenzoic acid N-(2′-hydroxyethyl)-amide, 2-aminobenzoic acid hydrazide, 3-aminobenzoic acid hydrazide, 4-aminobenzoic acid hydrazide, 3,4-diaminobenzoic acid hydrazide, 2-methoxy-4-aminobenzoic acid hydrazide, anthranilic acid N-2′-(o-aminobenzoyloxy)-ethyl-amide, anthranilic acid N-2′-(p-aminobenzoyloxy)-ethyl-amide, 4-amino-3-methoxybenzoic acid N-(2′-hydroxyethyl)-amide, 4-amino-3-methoxybenzoic acid hydrazide, 2-, 3-, or 4-amino-acetophenone, and mixtures comprising one or more of the foregoing compounds.

The structures of several compounds of formula 2 are listed in Table 1 below:

TABLE 1

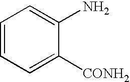

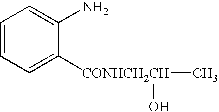

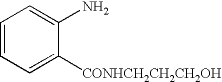

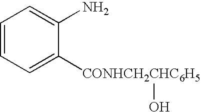

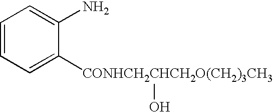

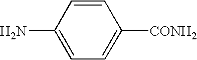

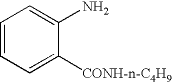

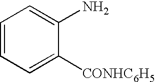

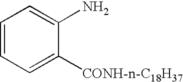

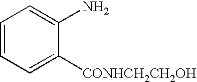

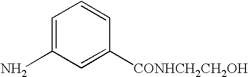

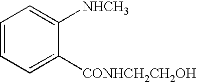

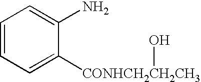

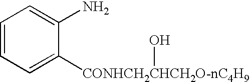

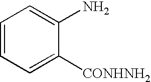

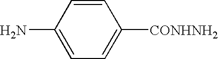

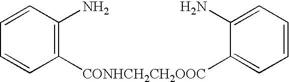

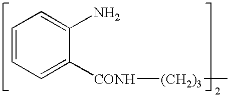

In another embodiment, the aromatic amine has the formula: 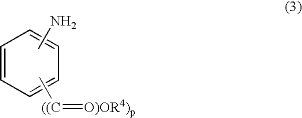
wherein p is 1 or 2 and R₄ is C₁ to C₁₈ alkyl.

Aromatic amines of formula 3 include, for example, ethyl-2-aminobenzoate, dimethyl aminoterephthalate, methyl anthranilate, ethyl-4-aminobenzoate, and mixtures comprising one or more of the foregoing aromatic amines. The structures of several compounds of formula 3 are listed in Table 2.

TABLE 2

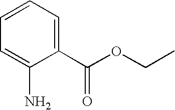

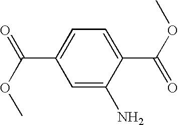

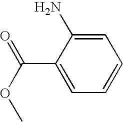

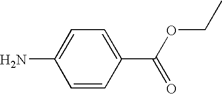

In yet another embodiment, the aromatic amine has the formula 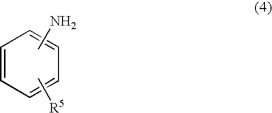
wherein R⁵ is H, or C₁ to C₁₈ alkyl.

Suitable compounds of formula 4 include aniline, p-toluidine, and mixtures comprising one or more of the foregoing aromatic amines.

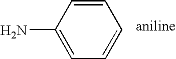

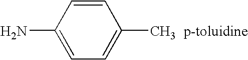

In another embodiment, the aromatic amine is of formula 5 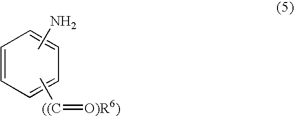
wherein R⁶ is C₁ to C₁₈ alkyl. Suitable compounds of formula 6 include 2-, 3-, and 4-aminoacetophenone.

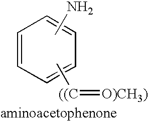

Effective amounts of aromatic amine are 0.001 to 10 parts by weight per hundred parts by weight of resin (phr). In one embodiment, amounts of 0.01 phr to 8 phr may be employed. In another embodiment, amounts of 0.05 phr to 6 phr may be employed. Lesser amounts tend to be ineffective, and greater amounts do not adversely affect the stabilization, but are not necessary, and thus may be uneconomical.

The stabilizer composition includes a co-stabilizer, including, for example a dihydropyridine, a polydihydropyridine, an amino alcohols, a perchlorate, a polyol, a sterically hindered amine, a hydrotalcite, a mercaptan-containing organic compound, and mixtures comprising one or more of the foregoing co-stabilizers.

Suitable dihydropyridines are of formula (6) 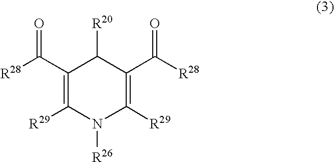
wherein each R²⁹ is independently a C₁ to C₃₆ alkyl group, such as a methyl or ethyl group. Each R²⁸ is independently hydrogen, —OR²¹, —NHR²¹, or —NR²¹R²², wherein R²¹ and R²² are each independently a C₁ to C₂₀ alkyl group, a C₁ to C₂₀ alkoxy group, or a C₂ to C₂₀ alkenyl group. Each of the foregoing may be substituted or unsubstituted with groups that do not adversely affect use of the composition. In one embodiment, the substitutent is an alkoxy group. In one embodiment, R²⁸ is —OR²¹, wherein R²¹ is a C₁ to C₆ alkyl group. Each R²⁰ is independently hydrogen, oxygen, halogen, or a C₁ to C₃₆ alkyl, alkenyl, aryl, alkaryl, or aralkyl group, wherein the carbon containing groups may be substituted or unsubstituted with groups that do not adversely affect use of the composition. R²⁶ is a hydrogen, a C₁ to C₂₀ alkyl group, a C₆ to C₃₆ aryl group, or a C₂ to C₂₀ alkenyl group. Each of the foregoing may be substituted or unsubstituted with groups that do not adversely affect use of the composition. In one embodiment, R²⁶ is hydrogen. Suitable dihydropyridines include, for example, 3,5-bis(ethoxycarbonyl)-2,6-dimethyl-1,4-dihydropyridine.

Alternatively, or in addition to a dihydropyridine, a polydihydropyridine of formula (4) may be used 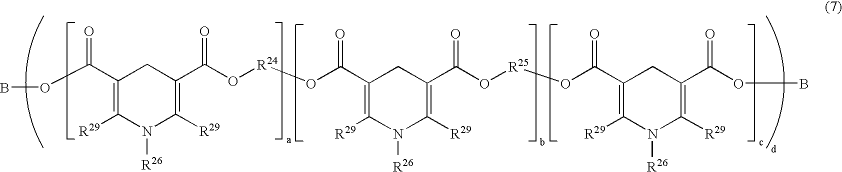
wherein B is a C₆ to C₁₈ aryl, C₂ to C₂₂ alkenyl, or C₁ to C₂₂ alkyl, each of which may be unsubstituted or substituted with a C₁ to C₁₈ alkoxy, a C₁ to C₁₈ alkylthio, hydroxy, acryloyloxy, methacryloyloxy, halogen, phenyl or naphthyl. Each R²⁹ is independently a C₁ to C₃₆ alkyl group, specifically a methyl or ethyl group. a and b are numbers from 0 to 20, c is 0 or 1, and d is a number from 1 to 6, with the proviso that d(a+b+c)>1 and (a+b)>0. R²⁴ and R²⁵ are each independently methylene, phenyl, or an alkylene group of the type (—CₚH₂ₚ—X—)ₜCₚH₂ₚ—, wherein p is a number from 2 to 18, t is a number from 0 to 10, and X is oxygen or sulfur. R²⁶ is a hydrogen, C₁ to C₂₀ alkyl group, a C₆ to C₃₆ aryl group, or a C₂ to C₂₀ alkenyl group. Each of the foregoing may be substituted or unsubstituted with groups that do not adversely affect use of the composition. In one embodiment, R²⁶ is hydrogen. Suitable polydihydropyridines include, for example thiodiethylene-bis[5-methoxycarbonyl-2,6-di methyl-1,4-dihydropyridine-3-carboxylate]. Effective amounts of dihydropyridine and/or polydihydropyridine, when present, are 0.01 phr to 5 phr.

Suitable amino alcohols have the structure shown in formula 8: 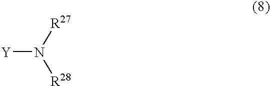
wherein Y is a substituted or unsubstituted C₁-C₃₆ alkyl, alkenyl, aryl, alkylaryl, or arylalkyl group. In one embodiment, Y is a C₁- to C₁₂ alkyl or aryl group, and in another embodiment Y is a C₁ to C₄ alkyl group comprising at least one hydroxy group.

R²⁷ and R²⁸ in formula (8) are each independently hydrogen or a substituted or unsubstituted C₁ to C₃₆ alkyl, alkenyl, aryl, alkylaryl, or arylalkyl group. In one embodiment, R²⁷ and R²⁸ are each independently hydrogen, or a C₁ to C₁₂ alkyl or aryl group, and in another embodiment hydrogen or a C₁ to C₄ alkyl group comprising at least one hydroxy group. Two of Y, R²⁷, or R²⁸ may join together to form a substituted or unsubstituted C₂ to C₃₆ carbocylic or heterocyclic group wherein the heteroatoms are oxygen or sulfur. It is not within the scope of the present invention that two of Y, R²⁷, or R²⁸ join together to form a substituted or unsubstituted heterocyclic group wherein the heteroatom(s) are nitrogen.

Suitable substituents for Y, R²⁷, and R²⁸ are those that do not adversely affect use of the thermal stabilizer composition, and include, for example, primary amines, carboxylic acids, carbonyl groups, halogens, C₂ to C₁₈ heterocycles comprising oxygen or sulfur in the ring, or secondary amines, tertiary amines, carboxylic esters, amides, or ethers substituted with alkyl, alkenyl, aryl, aralkyl or aryl groups, with the exception of heterocyclic rings containing only nitrogen and carbon as ring-forming atoms.

In one embodiment, Y, R²⁷, and R²⁸ can be substituted so as to provide the amino alcohol with two or more hydroxy groups. The two or more hydroxy groups may be present on one of Y, R²⁷ and R²⁸, or any combination of Y, R²⁷, and R²⁸. Suitable amino alcohols within the scope of formula (8) include, for example, tris(2-hydroxyethyl)amine, tris(2-hydroxy-1-propyl)amine, bis(2-hydroxyethyl)-2-hydroxy-1-propylamine, N-(n-butyl)-N,N-bis(2-hydroxyethyl)amine, N,N-bis(n-butyl)-N-(2-hydroxyethyl)amine, N-(3-n-butyloxy-2-hydroxy-1-propyl)-N,N-bis(2-hydroxyethyl)amine, and N-(1,3-dihydroxy-2-hydroxymethyl-2-propyl)-N,N-bis(2-hydroxyethyl)amine, and the like. Mixtures of amino alcohols may be used. Suitable amino alcohols within the scope of formula (8) include, for example, triethanolamine, tris(hydroxymethyl)aminomethane, N-methyl glucamine, N,N′-bis (2-hydroxyethyl)ethylene diamine, and mixtures comprising one or more of the foregoing amino alcohols. The amino alcohols, when present, may be used in amounts of 0.1 phr to 3 phr.

Suitable perchlorates include, for example, those of formula M(ClO₄)ₙ, wherein M is H, Li, Na, K, Mg, Ca, Sr, Zn, Al, La or Ce, and n is 1, 2 or 3, depending on the valence of M. The perchlorates may be complexed with a wide variety of alcohols, for example polyols, cyclodextrins, ether alcohols, ester alcohols, polyol partial esters, and mixtures comprising one or more of the foregoing alcohols. Dimers, trimers, oligomers, and polymers, such as di-, tri-, tetra- and poly-glycols, and di-, tri- and tetra-pentaerythritol or polyvinyl alcohol in various degrees of polymerization may also be used. Glycerol monoethers and glycerol monothioethers are preferred as polyol partial ethers. The perchlorates can be introduced in various known forms, for example in the form of a salt or an aqueous solution applied to a substrate, such as PVC, calcium silicate, zeolites, or hydrotalcites. The perchlorates may also be introduced as zeolite or hydrotalcite salts, formed for example, by ion exchange with the corresponding zeolite or hydrotalcite metal salts. When present, the perchlorates can be employed in an amount of, for example, 0.001 phr to 5 phr, or 0.01 phr to 1 phr.

Suitable polyols include, for example, sorbitol, pentaerythritol, dipentaerythritol, tripentaerythritol, bistrimethylolpropane, trimethylolpropane, inosite, polyvinyl alcohol, mannitol, lactose, tris(hydroxyethyl)isocyanurate, tetramethylolcyclohexanol, tetramethylolcyclopyranol, glycerol, diglycerol, polyglycerol, and mixtures comprising one or more of the foregoing polyols. The polyols can be used in an amount of, for example, 0.01 phr to 20 phr, or 0.1 phr to 10 phr.

Suitable epoxy compounds include, for example, epoxidized oils such as soybean oil, lard oil, olive oil, linseed oil, peanut oil, tung oil, cottonseed oil, and mixtures comprising one or more of the foregoing epoxy compounds. Other suitable epoxy compounds include, for example, epichlorohydrin/bis-phenol A resins, butoxypropylene oxide, glycidyl epoxystearate, epoxidized α-olefins, epoxidized glycidyl soyate, and epoxidized butyl toluate; the glycidyl esters of organic carboxylic acids, the glycidyl ethers of resorcinol, hydroquinone, 1,5-dihydroxynaphthalene, and glycerine; allyl glycidyl ether, butyl glycidyl ether, cyclohexane oxide, 4-(2,3-epoxypropoxy)acetophenone, mesityl oxide epoxide, 2-ethyl-3-propyl glycidamine, and mixtures comprising one or more of the foregoing epoxy compounds. The epoxy compound may be present in amounts of up to 30 phr.

Useful sterically hindered amines include, for example, monomeric, oligomeric, or polymeric 2,2,6,6-tetramethylpiperidine compounds. The nitrogen of the piperidine moiety may be substituted by, for example, hydrogen, C₁ to C₁₂ alkyl, C₃ to C₈ alkenyl, or C₇ to C₁₂ aralkyl. The C-4 carbon of the piperidine moiety may be substituted by, for example, hydrogen or oxygen or nitrogen-containing groups. Suitable 2,2,6,6-tetramethylpiperidine compounds include, for example, 4-hydroxy-2,2,6,6-tetramethylpiperidine, 1-benzyl-4-hydroxy-2,2,6,6-tetramethylpiperidine, 4-stearoyloxy-2,2,6,6-tetramethylpiperidine, 1,2,2,6,6-pentamethylpiperidin-4-yl-beta-(3,5-di-tert-butyl-4-hydroxyphenyl) propionate, di(2,2,6,6-tetramethylpiperidin-4-yl) succinate, 1-acetyl-2,2,6,6-tetramethylpiperidin-4-yl acetate, trimellitic acid tri(2,2,6,6-tetramethylpiperidin-4-yl) ester, and the like. The piperidines can be used in an amount of, for example 0.01 phr to 1 phr, or 0.1 phr to 0.5 phr.

Suitable mercaptan-containing organic compounds include, for example, alkyl mercaptans, mercapto esters, mercapto alcohols, mercapto acids, and the like, having 1 to 100 carbon atoms and 1 to 4 mercapto groups. Suitable mercaptan-containing organic compounds have structures illustrated by the following formulas: 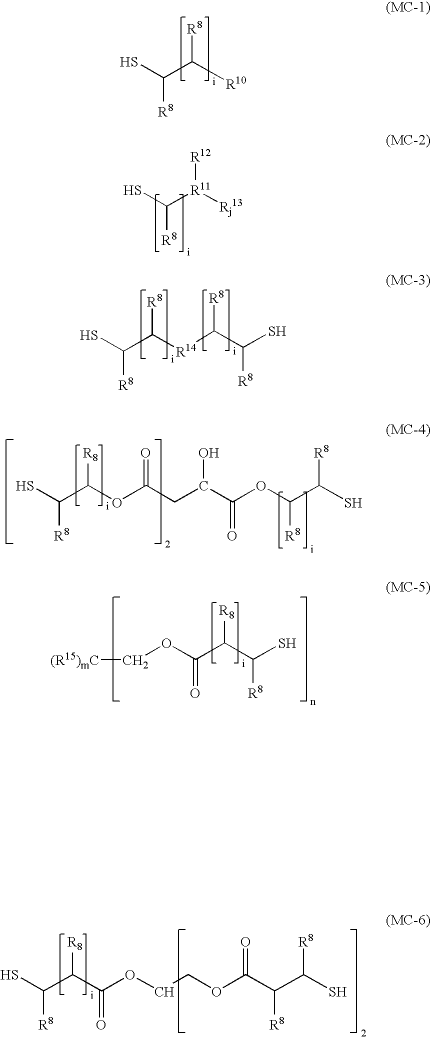
wherein

i=0-6; j=0-3; m=1-2; n=2-3, with the proviso that m+n=4;

R⁸ is —H, C₁ to C₁₈ alkyl, or C₁ to C₃₆ aryl;

R⁹ and R¹⁰ are each independently —H, —OH, —SH, C₁ to C₁₈ alkyl, aryl, R¹⁶C(═O)O—, or R¹⁶OC(═O)—;

R¹¹ is cycloalkyl, cycloalkenyl, or phenyl;

R¹² is —H, —OH, —SH, C₁ to C₁₈ alkyl, C₆ to C₁₈ aryl, R¹⁶C(═O)O—, R¹⁶OC(═O)—, with the proviso that in formula MC2, when R¹¹ is phenyl, R¹² is —OH and i=0, the —SH groups are on non-adjacent carbon atoms;

R¹³ is —H or a divalent group which may comprise halogen, hydroxy, mercapto or alkyl substituents and which when R¹¹ is phenyl combines with the phenyl to form a naphthalene ring;

R¹⁴ is divalent, and is —OC(═O)R¹⁷C(═O)O—, —OC(═O)CH═CHC(═O)O—, or —C(═O)OR¹⁷OC(═O)—;

R¹⁵ is C₁ to C₁₂ alkyl, preferably —CH₃, —CH₂CH₃; C₁ to C₁₂ hydroxyalkyl, such as hydroxymethyl; or

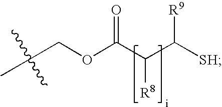

R¹⁶ is —H, C₁ to C₂₄ alkyl, C₁ to C₂₄ alkenyl, C₆ to C₃₆ aryl, C₇ to C₃₆ aralkyl, C₇ to C₃₆ alkaryl, C₁ to C₁₆ cycloalkyl, or C₁ to C₃₆ cycloalkenyl; and

R¹⁷ is C₆ to C₃₆ arylene, C₁₋₈ alkylenyl, —(CH₂CH₂O)_{b}CH₂CH₂— where b=1-6, or 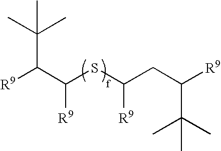
where f=1 or 2.

The mercaptan-containing organic compounds may comprise a compound according to formula MC1 where R⁸ is —H; R⁹ is —H; R¹⁰ is —OH, R¹⁶C(═O)O—, or R¹⁶OC(═O); and i=1; compounds according to formula MC2 where R¹¹ is phenyl; R⁸ is —H; R¹² is —H; R¹³ is —H; j=1, and i=1; compounds according to formula MC3 where R⁸ is —H; R¹⁴ is —OC(═O)CH═CHC(═O)O—; and i=1; compounds according to formula MC4 where R⁹ is —H; and i=1; and compounds according to formula MC5 where R¹⁵ is —C₂H₅ or 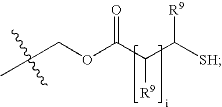
and R⁸ is —H; and i=1; and compounds according to formula MC6 where R⁸ is —H; and i=1.

In one embodiment, the mercaptan-containing organic compound is a mercaptoester or reverse ester as in Formulas MC-1 or MC-2, wherein each R⁹, R¹⁰, or R¹² is independently R¹⁶C(═O)O— or R¹⁶OC(═O)—; or MC-3, MC-4, MC-5, or MC-6. Suitable esters include, for example, stearyl thioglycolate, 2-ethylhexyl thioglycolate, diethylene glycol bis(thioglycolate), and mixtures comprising one or more of the foregoing esters. Suitable reverse esters include, for example, 2-mercaptoethyl stearate, 2-mercaptoethyl caproate, 2-mercaptoethyl tallate, and mixtures comprising one or more of the foregoing reverse esters.

Suitable hydrotalcites include, for example, those having the formula Al₂O₃ 6MgO CO₂ 12H₂O, Mg_{4,5} Al₂(OH)₁₃ CO₃ 5H₂O, 4MgO Al₂O₃ CO₂ 9H₂O, 4MgO Al₂O₃CO₂ 6H₂O, ZnO 3MgO Al₂O₃ CO₂ 8-9H₂O, or ZnO 3MgO Al₂O₃ CO₂ 5-6H₂O. Suitable zeolites (alkali and alkaline earth aluminosilicates) include, for example, zeolite A, sodalite, zeolite Y, zeolite X, zeolite P, zeolites MAP, zeolites K-F, potassium offretite, zeolite T, and the like, and mixtures comprising at least one of the foregoing zeolites. Hydrotalcites and/or zeolites can be used in an amount of, for example, 0.1 phr to 20 phr, or 0.1 phr to 10 phr

The composition may further comprise an additional co-stabilizer such, as, for example, phosphites and mercaptocarboxylic acid esters, and mixtures comprising one or more of the foregoing co-stabilizers.

Suitable mercaptocarboxylic acid esters include, for example, esters of thioglycolic acid, thiomalic acid, mercaptopropionic acid, mercaptobenzoic acids, or thiolactic acid. Mercaptocarboxylic esters can be used in an amount of, for example, 0.01 phr to 10 phr, or 0.05 phr to 5 phr, or 0.1 phr to 3 phr.

Suitable phosphites include, for example, trialkylphosphites such as trioctyl phosphite, tridecyl phosphite, tridodecyl phosphite, tri(tetradecyl) phosphite, tricyclohexyl phosphite, tristearyl phosphite, distearyl-pentaerythritol diphosphite, or trioleyl phosphite; triaryl phosphites such as triphenyl phosphite, tricresyl phosphite, or tris-p-nonylphenyl phosphite; alkyldiaryl phosphites such as phenyldidecyl phosphite or (2,4-di-tert-butylphenyl)didodecyl phosphite; dialkylaryl phosphites; thiophosphites such as trithiohexyl phosphite, trithiooctyl phosphite, trithiolauryl phosphite, or trithiobenzyl phosphite; or mixtures comprising any one or more of the foregoing phosphites. The phosphites can be used in an amount of, for example, 0.01 phr to 10 phr, or 0.05 phr to 5 phr, or 0.1 phr to 3 phr.

As used herein, the term halogen-containing vinyl polymer means a halogen-containing polymer in which the halogens are attached directly to a carbon atom. Suitable halogen-containing polymers include, for example, chlorinated polyethylene having 14 to 75%, e.g., 27%, chlorine by weight, chlorinated natural and synthetic rubber, rubber hydrochloride, chlorinated polystyrene, chlorinated poly(vinylidene chloride), chlorinated poly(vinyl chloride), poly(vinyl bromide), poly(vinyl fluoride), other vinyl chloride polymers, and mixtures comprising one or more of the foregoing polymers. The vinyl chloride polymers known as polyvinyl chloride (PVC) are made from vinyl chloride monomers alone or a mixture of monomers comprising, for example, 70% by weight of vinyl chloride, based on the total monomer weight. Suitable co-monomers include, for example, vinyl acetate, vinyl butyrate, vinyl benzoate, vinylidene chloride, trichloroethylene, 1-fluoro-2-chloroethylene, diethyl fumarate, diethyl maleate, methyl acrylate, 2-ethylhexyl acrylate, methyl alpha-chloroacrylate, methyl methacrylate, ethyl methacrylate, butyl methacrylate, styrene, vinyl ketones such as vinyl methyl ketone and vinyl phenyl ketone, acrylonitrile, chloroacrylonitrile, allylidene diacetate, chloroallylidene diacetate, and vinyl ethers such as vinyl ethyl ether, vinyl phenyl ether, the vinyl ether prepared by the reaction of one mole of acrolein with one mole of ethylene glycol divinyl ether, and mixtures comprising one or more of the foregoing co-monomers. Suitable halogen-containing vinyl copolymers include, for example, vinyl chloride-vinyl acetate, vinyl chloride-vinyl acetate (87:13), vinyl chloride-vinyl acetate-maleic anhydride (86:13:1), vinyl chloride-vinylidene chloride (95:5); vinyl chloride-diethyl fumarate (95:5), vinyl chloride 2-ethylhexyl acrylate (80:20), and mixtures comprising one or more of the foregoing copolymers.

A rigid halogen-containing vinyl polymer composition is one that does not contain a plasticizer. A semi-rigid halogen-containing vinyl polymer composition contains 1 to 25 parts of a plasticizer per 100 parts by weight of the halogen-containing vinyl polymer. A flexible halogen-containing vinyl polymer composition contains 25 to 100 parts of a plasticizer per 100 parts by weight of the halogen-containing vinyl polymer. Suitable plasticizers include, for example, alkyl esters of polyacids in which there are 1 to 3 alkyl groups having 8 to 12 carbon atoms. Suitable alkyl groups of the alkyl ester include, for example, n-octyl, 2-ethylhexyl, decyl, dodecyl, and mixtures comprising one or more of the foregoing alkyl groups. Suitable polyacids for the alkyl ester include, for example, phthalic acid, trimellitic acid, benzoic acid, adipic acid, sebacic acid, glutaric acid, phosphates, and the like. Polymeric plasticizers are also suitable.

Optionally, the halogen-containing polymer compositions may include other conventional additives such as, for example, antioxidants, lubricants, fillers, pigments, impact modifiers, processing aids, blowing agents, dyes, ultraviolet light absorbing agents, densifying agents, biocides, and mixtures comprising one or more of the foregoing additives. Suitable amounts of the foregoing additives are readily determined by one of ordinary skill in the art depending on the desired final properties and end use of the compositions. In general, each additive is present in an amount of 0.01 to 10 wt %, preferably 0.1 to 5 wt %, based on the total weight of the halogen-containing vinyl polymer.

Suitable antioxidants include, for example, phenolic antioxidants such as 2,6-di-t-butyl-p-cresol, butylated hydroxyanisole, 4,4′-thiobis(6-t-butyl-m-cresol), 4,4′-cyclohexylidenediphenol, 2,5-di-t-amyl hydroquinone, 4,4′-butylidene bis(6-t-buytl-m-cresol), hydroquinone monobenzyl ether, 2,2′-methylene-bis(4-methyl-6-t-butyl phenol), 2-t-butyl-4-dodecyloxy phenol, p-amino phenol, N-lauryloxy-p-amino phenol, 4,4′-thiobis(3-methyl-6-t-butyl phenol), bis [o-(1,1,3,3-tetramethyl butyl)phenol]sulfide, 4-dodecyoxy-2-hydroxybenzophenone, n-dodecyl ester of 3-hydroxy-4-(phenyl carbonyl)phenoxyacetic acid, t-butyl phenol, and mixtures comprising one or more of the foregoing antioxidants.

Suitable lubricants include, for example, paraffin waxes, salts of fatty acids, low molecular weight polyethylene (i.e., polyethylene wax), fatty acid amides (i.e., laurimide and stearamide), bis amides (i.e., decamethylene, bisamide), fatty acid esters (e.g., butyl stearate, glyceryl stearate, linseed oil, palm oil, decyloleate, corn oil, cottonseed oil, and the like), and mixtures comprising one or more of the foregoing lubricants. Suitable fillers include, for example, calcined clays, calcium carbonate, talcs, and mixtures comprising one or more of the foregoing fillers. Suitable pigments include, for example, titanium dioxide, carbon black, iron oxide, and mixtures comprising one or more of the foregoing pigments.

In general, the above-described thermal stabilizer compositions are provided as a one-part mixture formulated so as to provide an aromatic amine in an amount effective to provide thermal stability. As other optional additives may also be present in the one-part mixture, the particular amount of each component may vary from 0.1 to 99.9% percent by weight, or 1.0 to 99.0% by weight based on the total weight of the one-part mixture. Particular amounts effective to result a synergistic improvement in thermal stability are readily determined by one of ordinary skill in the art.

The halogen-containing vinyl polymer compositions may be prepared by blending under low or high shear. Likewise, the thermal stabilizer compositions may be incorporated in the halogen-containing vinyl polymer composition by mixing the components thereof and the polymer in an appropriate mill or mixer or by another method that provides uniform distribution of the stabilizer throughout the polymer. Depending on the compatibility and physical state (i.e., liquid or solid) the components of the blend may require heating to form a uniform stabilized polymer composition having the desired performance characteristics.

The stabilized halogen-containing vinyl polymer composition can be used to form a variety of rigid articles such as, for example, house siding, window profiles, and pipe using a variety of techniques to shape the articles such as, for example, molding, extrusion, and injection molding.

In one embodiment, a synergistic combination comprising an aromatic amine and a co-stabilizer provides can provide improved long-term color stability, preferably together with the improved early color. In one embodiment, the co-stabilizer comprises a perchlorate, an amino alcohol, and a polyol.

The invention is further illustrated by the following examples, wherein PVC compositions for thermal stability testing were prepared by mixing, under high shear, 100 parts by weight of PVC resin, pigment (0.1 to 2.0 phr), mold release agents (0.5-2 phr), co-stabilizer (1-10 phr epoxidized soybean oil), and lubricants (0.2 to 5.0 phr), together with the stabilizer compositions shown in the Tables. The mixed compositions were then heated in a two-roll mill at 390° F. (199° C.) and samples were removed at the indicated time intervals and formed into chips. Color change (as reflected by dE) and yellowness (YI) of each chip was measured using a Hunter Labs (L, a, b) calorimeter.

Examples 1-5 show the synergistic effects obtained using a combination of an aromatic amine and a perchlorate salt at different ratios.

TABLE 3

| | Example | | | | |
|---|---|---|---|---|---|
| | 1* | 2 | 3 | 4 | 5* |
| Component | | | | | |
| Anthranilamide | 1.0 | 0.75 | 0.5 | 0.25 | 0 |
| Sodium perchlorate | 0 | 0.25 | 0.5 | 0.25 | 1.0 |
| dE at minute | | | | | |
| 1 | 19.0 | 20.0 | 21.2 | 26.9 | 32.4 |
| 2 | 25.9 | 23.5 | 26.1 | 32.3 | 39.3 |
| 3 | 31.8 | 29.2 | 31.0 | 35.9 | 43.1 |
| 4 | 39.6 | 32.7 | 33.6 | 39.3 | 46.5 |
| 5 | 47.7 | 35.9 | 36.2 | 42.3 | 49.7 |
| 6 | | 39.5 | 39.8 | 47.0 | |
| 7 | | 43.9 | 44.5 | 49.1 | |
| 8 | | | | | |
| 9 | | | | | |

*Control

As shown in Table 3, the combination of an aromatic amine and a perchlorate provides improved stabilization over either stabilizer alone at the same amount of total stabilizer. Comparing examples 2-4, an excess of aromatic amine over perchlorate appears to provide the best stabilization.

Examples 6-10 show the synergistic effects obtained using a combination of equimolar amounts of different aromatic amines and triethanolamine.

TABLE 4

| | Example | | | | |
|---|---|---|---|---|---|
| | 6 | 7 | 8 | 9 | 10 |
| Component | | | | | |
| Dimethyl | 0.28 | 0 | 0 | 0 | 0 |
| aminoterephthalate | | | | | |
| Methyl anthranilate | 0 | 0.20 | 0 | 0 | 0 |
| Ethyl-2-aminobenzoate | 0 | 0 | 0.22 | 0 | 0 |
| Anthranilamide | 0 | 0 | 0 | 0.18 | 0 |
| Ethyl-4-aminobenzoate | 0 | 0 | 0 | 0 | 0.22 |
| Triethanolamine | 0.10 | 0.10 | 0.10 | 0.10 | 0.10 |
| dE at minute | | | | | |
| 1 | 15.6 | 15.9 | 16.5 | 16.6 | 16.0 |
| 2 | 17.2 | 17.9 | 18.2 | 18.5 | 18.0 |
| 3 | 18.7 | 20.3 | 20.9 | 19.8 | 21.2 |
| 4 | 23.9 | 23.6 | 23.8 | 22.7 | 23.7 |
| 5 | 28.4 | 29.2 | 28.2 | 26.6 | 27.9 |
| 6 | 37.0 | 35.1 | 36.3 | 33.0 | 35.4 |
| 7 | 43.2 | 41.8 | 42.3 | 39.4 | 41.2 |
| 8 | 48.7 | 58.1 | 47.3 | 44.3 | 46.2 |
| 9 | 50.7 | 51.8 | 51.8 | 49.1 | 49.6 |
| 10 | | 52.2 | | | |

Examples 6-10 show that equimolar amounts of various aromatic amines exhibit similar stabilization when combined with triethanolamine.

Examples 11-13 show the synergistic effects obtained using a combination of an aromatic amine, an amino alcohol (triethanolamine), a perchlorate, and a polyol (sorbitol).

TABLE 5

| | Example | | |
|---|---|---|---|
| | 11* | 12* | 13 |
| Component | | | |
| Aniline | 0 | 0.20 | 0.2 |
| Triethanolamine | 0.10 | | 0.10 |
| Sodium perchlorate | 0.018 | | 0.018 |
| Sorbitol | 0.10 | | 0.10 |
| dE at minute | | | |
| 1 | 18.8 | 17.1 | 16.7 |
| 2 | 23.4 | 22.9 | 16.9 |
| 3 | 26.0 | 31.1 | 19.0 |
| 4 | 29.2 | 41.8 | 20.1 |
| 5 | 32.9 | 49.8 | 22.4 |
| 6 | 34.2 | 60.3 | 25.1 |
| 7 | 37.6 | | 27.5 |
| 8 | 39.7 | | 31.0 |
| 9 | 42.4 | | 34.8 |
| 10 | 45.3 | | 37.2 |
| 11 | 49.6 | | 44.1 |
| 12 | 50.6 | | 50.1 |

*Control

The above data show that aniline provides improved stabilization when added to a combination of triethanolamine, perchlorate, and sorbitol. Thus, an aromatic amine provides suitable stability to PVC compositions when combined with other stabilizers.

Examples 14-20 show the synergistic effects obtained using a combination of an aromatic amine with a perchlorate, triethanolamine, and sorbitol.

TABLE 6

| | Example | | | | | | |
|---|---|---|---|---|---|---|---|
| | 14* | 15* | 16 | 17* | 18 | 19* | 20 |
| Component | | | | | | | |
| Sodium perchlorate | 0.018 | | 0.018 | | 0.018 | | 0.018 |
| Triethanolamine | 0.1 | | 0.1 | | 0.1 | | 0.1 |
| Sorbitol | 0.1 | | 0.1 | | 0.1 | | 0.1 |
| 2-aminoacetophenone | | 0.2 | 0.2 | | | | |
| p-toluidine | | | | 0.2 | 0.2 | | |
| 4-nitroaniline | | | | | | 0.2 | 0.2 |
| dE at minute | | | | | | | |
| 1 | 18.9 | 19.9 | 19.1 | 19.0 | 18.6 | 21.0 | 19.5 |
| 2 | 25.4 | 27.8 | 20.8 | 24.0 | 20.2 | 29.9 | 22.2 |
| 3 | 29.4 | 39.9 | 24.6 | 31.3 | 22.4 | 43.8 | 25.1 |
| 4 | 32.2 | 53.8 | 25.9 | 41.9 | 24.2 | 55.0 | 28.8 |
| 5 | 36.1 | | 27.8 | 53.0 | 28.3 | | 31.1 |
| 6 | 42.4 | | 31.0 | | 32.0 | | 35.6 |
| 7 | 47.8 | | 32.3 | | 37.2 | | 39.0 |
| 8 | 50.0 | | 39.7 | | 42.5 | | 44.4 |
| 9 | 51.6 | | 42.3 | | 47.0 | | 46.9 |
| 10 | 54.1 | | 47.0 | | | | 50.1 |
| 11 | | | 48.2 | | | | |
| 12 | | | 50.2 | | | | |

*Control

As can be seen from Table 6, the addition of an aromatic amine such as 2-aminoactophenone, p-toluidine or 4-nitroaniline to a stabilizer composition comprising sodium perchlorate, triethanolamine and sorbitol improves stabilization.

Examples 21-29 show the synergistic effects obtained using a combination of an aromatic amine with a perchlorate, triethanolamine, and sorbitol.

TABLE 7

| | Example | | | | | | | | |
|---|---|---|---|---|---|---|---|---|---|
| | 21* | 22* | 23 | 24* | 25 | 26* | 27 | 28* | 29 |
| Component | | | | | | | | | |
| Sodium | 0.018 | | 0.018 | | 0.018 | | 0.018 | | 0.018 |
| perchlorate | | | | | | | | | |
| Triethanolamine | 0.1 | | 0.1 | | 0.1 | | 0.1 | | 0.1 |
| Sorbitol | 0.1 | | 0.1 | | 0.1 | | 0.1 | | 0.1 |
| Ethyl-2- | | 0.2 | 0.2 | | | | | | |
| aminobenzene | | | | | | | | | |
| Dimethyl | | | | 0.2 | 0.2 | | | | |
| aminoterephthalate | | | | | | | | | |
| Anthranilamide | | | | | | 0.2 | 0.2 | | |
| Ethyl-4- | | | | | | | | 0.2 | 0.2 |
| aminobenzoate | | | | | | | | | |
| dE at minute | | | | | | | | | |
| 1 | 18.8 | 20.4 | 17.2 | 23.9 | 17.0 | 18.9 | 17.0 | 19.3 | 17.3 |
| 2 | 26.0 | 30.3 | 22.2 | 35.8 | 20.3 | 24.2 | 18.9 | 25.4 | 19.5 |
| 3 | 31.5 | 44.9 | 28.2 | 48.9 | 24.4 | 38.1 | 21.5 | 33.7 | 22.4 |
| 4 | 32.3 | 56.0 | 28.1 | 54.3 | 29.0 | 48.1 | 24.2 | 47.2 | 26.5 |
| 5 | 36.6 | | 28.8 | | 31.6 | 53.5 | 24.7 | 57.0 | 29.0 |
| 6 | 42.5 | | 29.9 | | 34.5 | | 26.6 | | 30.1 |
| 7 | 46.3 | | 35.7 | | 36.2 | | 29.5 | | 31.2 |
| 8 | 49.3 | | 39.1 | | 42.1 | | 34.8 | | 36.6 |
| 9 | 51.1 | | 46.2 | | 44.6 | | 35.9 | | 38.4 |
| 10 | | | 49.1 | | 52.2 | | 36.4 | | 46.0 |
| 11 | | | | | | | 48.5 | | 49.1 |
| 12 | | | | | | | 50.4 | | 52.3 |

*Control

As can be seen from Table 7, the addition of an aromatic amine such as ethyl-2-aminobenzoate, dimethyl aminoterephthalate, anthranilamide, or ethyl-4-aminobenzoate to a stabilizer composition comprising sodium perchlorate, triethanolamine and sorbitol improves stabilization.

All ranges disclosed herein are inclusive and combinable.

1. A stabilizer composition comprising an aromatic amine of the formula 1: 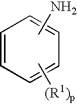
wherein p is 1 or 2, and wherein each R¹ is independently H, NO₂, alkenyl, alkoxy groups, C₁ to C₁₈ ester alkyl, C₁ to C₁₈ alkanoyl, or —(C═O)R², wherein each R² group is independently unsubstituted or substituted by one to three —OH, C₁ to C₄ alkoxy, phenoxy groups, or a combination thereof; and
a co-stabilizer, wherein the co-stabilizer is a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers.

2. The stabilizer composition of claim 1, wherein the aromatic amine is of the formula 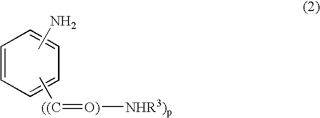
wherein p is 1 or 2; and each R³ is independently —OH, —NH₂, or C₁ to C₁₈ alkyl, phenyl, or (aryl)alkyl, or a mixture thereof; 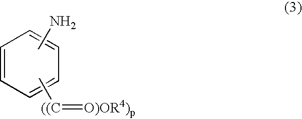
wherein p is 1 or 2 and R⁴ is C₁ to C₁₈ alkyl; 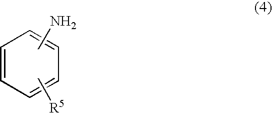
wherein R⁵ is H, or C₁ to C₈ alkyl; or 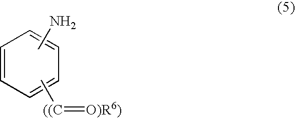
wherein R⁶ is C₁ to C₁₈ alkyl.

3. The stabilizer composition of claim 1, wherein the aromatic amine is ethyl 2-aminobenzoate, dimethyl aminoterephthalate, ethyl 4-aminobenzoate, anthranilamide, 4-nitroaniline, p-toluidene, 2-aminoacetophenone, or a mixture comprising one or more of the foregoing aromatic amines.

4. The stabilizer composition of claim 2, wherein the co-stabilizer is an amino alcohol, a perchlorate, a polyol, or a mixture comprising one or more of the foregoing co-stabilizers.

5. The stabilizer composition of claim 4, wherein the co-stabilizer comprises an amino alcohol, a perchlorate salt, and a polyol.

6. A method of stabilizing a composition comprising adding to a halogen-containing vinyl polymer composition an aromatic amine of the formula: 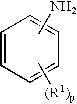
wherein p is 1 or 2, and wherein each R¹ is independently H, NO₂, alkenyl, alkoxy, C₁ to C₁₈ ester alkyl, C₁ to C₁₈ alkanoyl, or —(C═O)R², wherein each R² group is independently unsubstituted or substituted by one to three —OH, C₁ to C₄ alkoxy groups, phenoxy groups, or a combination thereof; and
a co-stabilizer, wherein the co-stabilizer is a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers.

7. A polymeric composition, comprising
a halogen-containing vinyl polymer; and
a stabilizer composition comprising an aromatic amine of the formula 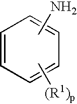
wherein p is 1 or 2, and wherein each R¹ is independently H, NO₂, alkenyl, alkoxy, C₁ to C₁₈ ester alkyl, C₁ to C₁₈ alkanoyl, or —(C═O)R², wherein each R² group is independently unsubstituted or substituted by one to three —OH, C₁ to C₄ alkoxy groups, phenoxy groups, or a combination thereof; and
a co-stabilizer, wherein the co-stabilizer is a dihydropyridine, a polydihydropyridine, an amino alcohol, a perchlorate, a polyol, a sterically hindered amine, a hydrotalcite, a mercaptan-containing organic compound, or a mixture comprising one or more of the foregoing co-stabilizers.

8. The polymeric composition of claim 7, wherein the aromatic amine is of the formula 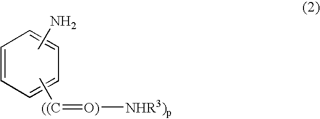
wherein p is 1 or 2; and each R³ is independently —OH, —NH₂, or C₁ to C₁₈ alkyl, phenyl, or (aryl)alkyl, or a mixture thereof; 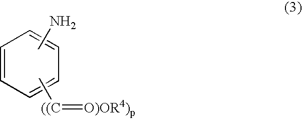
wherein p is 1 or 2 and R⁴ is C₁ to C₁₈ alkyl; 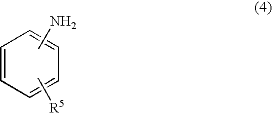
wherein R⁵ is H, or C₁ to C₁₈ alkyl; or 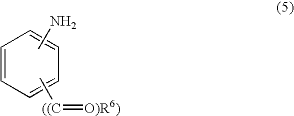
wherein R⁶ is C₁ to C₁₈ alkyl.

9. The polymeric composition of claim 8, wherein the co-stabilizer is a perchlorate, an amino alcohol, a polyol, or a mixture comprising one or more of the foregoing co-stabilizers.

10. An article comprising the stabilized polymeric composition of claim 7.

11. An article comprising the stabilized polymeric composition of claim 8.

12. An article comprising the stabilized polymeric composition of claim 9.
